(19) United States
(12) Patent Application Publication
(10) Pub. No.: US 2012/0301642 A1
(43) Pub. Date: Nov. 29, 2012

(54) SMART WINDOW

(75) Inventor: Philip Mark Shryane ROBERTS, Woodcote (GB)

(73) Assignee: SHARP KABUSHIKI KAISHA, Osaka (JP)

(21) Appl. No.: 13/116,535

(22) Filed: May 26, 2011

(51) Int. Cl. E06B 3/66; B32B 17/10; F21V 9/00; B05D 5/06; B05D 1/36; B32B 5/16; B32B 27/18

(52) U.S. Cl. 428/34; 428/328; 428/141; 428/404; 427/162; 427/164; 252/582

(57) ABSTRACT

A core-shell nanoparticle which includes a core formed of a transparent material and a shell including vanadium dioxide (VO₂) doped to have a semiconductor-metal phase transition within a range of 10° C. to 40° C. A ratio of thicknesses of the core to the shell is in a range of 1:1 to 50:1.

### TECHNICAL FIELD

This invention relates to materials that control heat flow in buildings and structures. In particular, it relates to a ‘Smart Window’ that controls the flow of solar radiant heat into a building, in order to improve thermal comfort and reduce heating/air conditioning costs. Further, it relates to a method to make such a window.

### BACKGROUND ART

There is a need to better control solar and internally generated heat in buildings and structures. Transmission of solar radiation through windows provides a significant component of the solar heat load on a building. Controlling how the windows transmit and reflect different spectral components of the incident solar radiation can be used to affect both the light level in the building, and the solar heat load upon it.

Conventional glass is designed to be transparent in the visible part of the electromagnetic spectrum (400 nm-700 nm) to allow visible light to pass through it. It also displays significant transmission in the near infra-red (NIR) part of the electromagnetic spectrum (700 nm-2500 nm). Solar radiation occurs across this entire range (400 nm-2500 nm) so conventional windows can transmit both visible light and near-infra-red ‘heat’ from the sun.

In some situations it is desirable to reduce both the amount of solar visible and solar NIR radiation passing through a glazing unit. This has been achieved in the past literature using tinted or ‘mirror’ glass. Such materials absorb or reflect a fixed fraction of visible and near infra-red radiation in order to reduce glare and heating from the sun. An example of this type of product is the Reflective Stainless Steel VS glass products available from Viracon, Inc.

In other situations it is desirable to pass only the visible part of the incident solar light. Such materials are also described in the prior art and are referred to as “spectrally selective materials”. They have a fixed, wavelength dependent transmission. Such materials are usually transparent in the visible range (400 nm-700 nm) and reflective in the near infra-red range (700 nm-2500 nm). An example of this type of product is V-Kool® made by Novomatrix Pte Ltd., which uses multilayers of silver and conductive oxide to achieve high NIR reflectivity.

Still other situations require that the spectral transmission can be modified according to the requirements of the user of the building. Such adaptive techniques are widely described in the past literature, based on electrochromic windows, suspended particle displays and gaschromic devices. However, these adaptive techniques can be power hungry, have limited optical adaptability or are difficult to implement. US20030193709 Switchable electro-optical laminates, (P. Mallya, et al.; published Oct. 16, 2003) describes an electrically switchable laminate construction for applications including smart windows and other uses in which light management is desired. The response of the material is determined by the strength of the applied electric field. U.S. Pat. No. 6,630,974 Super-wide-angle cholesteric liquid crystal based reflective broadband polarizing films, (H. Galabova, et al.; published Oct. 7, 2003) describes another electrically controllable cholesteric liquid crystal film that uses varying pitch helix structures aligned perpendicular to the surface of the film for broadband reflection and transmission of circularly polarized light.

Closer to the current invention are materials that change optical properties depending on temperature, so called thermochromics. Conventional thermochromic dyes are unsuitable for use in Smart Windows—they are neither sufficiently UV stable, nor available with absorption bands across the whole solar spectrum: 400 nm-700 nm (VIS) and 700-2500 nm (NIR).

Solid state thermochromic materials have been investigated as an alternative thermochromic material. One such material is vanadium dioxide, which undergoes a semiconductor-metal transition at ˜68° C. associated with a change in crystal structure from monoclinic to tetragonal. The phase transition can be lowered through doping with W, Al and Mg to ˜25° C. Thin films of VO₂ show modulation of reflectance at wavelengths >2000 nm—the metallic phase becomes reflective whereas the semiconductor phase is transparent (WO2010/038202A1 “Thermochromic material and fabrication thereof”, C. Granqvist, et al., published Apr. 8, 2010). For a Smart Window to modify the transmission of solar NIR radiation, materials should change transmission in the shorter wavelength range 700 nm-2500 nm, therefore VO₂ films are not suitable.

The optical properties of VO₂ nanoparticles have recently been calculated (Nanothermochromics: Calculations for VO₂ nanoparticles in dielectric hosts show much improved luminous transmittance and solar energy transmittance modulation, S. Li, et al., Journal of Applied Physics, 108, 063525 (2010)), and show modulation at shorter wavelengths than VO₂ films. Here, the optical effect is caused by the ‘switching on’ of a surface plasmon resonance (SPR) in the metallic phase, which provides absorption between 1200 nm-1500 nm. However, these particles (50 nm diameter) do not absorb over the whole solar NIR range (700 nm-2500 nm). They also show undesirable scattering for a “see-through” window, and do not control re-radiation of the absorbed solar energy.

### SUMMARY OF INVENTION

Prior art technologies therefore provide fixed or electrically controllable, spectrally selective performance. Fixed performance cannot adapt to changing conditions, and electrically controllable devices require complicated wiring and control circuits. Furthermore, some of the aforementioned prior art provides control of radiation over only a limited wavelength range.

The focus of this invention is a glazing unit which can respond to the changing environmental temperature conditions according to its internal construction and choice of constituent materials. At low temperatures it should be transparent to solar visible and NIR radiation. At higher temperatures it should be able to transmit or reflect NIR radiation from the sun in the approximate range 1000 nm to 1500 nm, and more preferably in the range 700 nm to 2500 nm. It has neither fixed spectral transmission properties nor electrically switchable spectral transmission properties. The responsive properties of the glazing unit are determined by the inherent phase behaviour of its constituent materials.

Such windows can be used to improve thermal comfort, reduce heat load and reduce requirements for air conditioning in any structure that contains glass or plastic-based glazing units including, but not limited to, buildings, greenhouses, conservatories etc.

This invention is considered innovative at least in that:
There is no previous description of VO₂ core-shell particles which are designed to provide wider tunability of SPR than solid particles (1000 nm-2500 nm compared to 1000 nm-1500 nm for solid particles) and are incorporated into a smart window
The particle size is chosen to eliminate scattering: <50 nm
No practical thermochromic smart window has previously been described that uses a low E coating on an internal surface to restrict re-radiation of absorbed solar energy

According to an aspect of the invention, a core-shell nanoparticle is provided which includes a core formed of a transparent material and a shell including vanadium dioxide (VO₂) doped to have a semiconductor-metal phase transition within a range of 10° C. to 40° C. A ratio of thicknesses of the core to the shell is in a range of 1:1 to 50:1.

In accordance with another aspect, the ratio is in a range of 1:1 to 10:1.

According to another aspect, the nanoparticle has a surface plasma resonance (SPR) within a range of 1000 nm-2500 nm.

According to another aspect, a size of the nanoparticle is in a range of 1 nm-50 nm.

In accordance with yet another aspect, the core is made of any one or more of silicon dioxide, titanium dioxide, zirconium dioxide or barium sulphate.

In yet another aspect, the VO₂ is doped with any one or more of W, Al, Mg, Nb, Ta, Ir or Mo.

According to another aspect, a film is provided which includes a plurality of nanoparticles as described herein dispersed in a transparent polymer host.

According to another aspect, a glazing unit is provided which includes a transparent substrate; and a VO₂ containing layer on a surface of the transparent substrate, the VO₂ containing layer comprising a plurality of nanoparticles as described herein.

According to another aspect, the transparent substrate is a glass substrate.

In accordance with another aspect of the invention, a double glazing unit includes an outer pane including a glazing unit as described herein and an inner pane adjacent the outer pane, the inner pane including another transparent substrate.

According to still another aspect, the VO₂ containing layer is formed on the inner surface of the outer pane.

In accordance with yet another aspect, the double glazing unit includes a thermally reflective layer on the inner surface of the inner pane.

According to yet another aspect of the invention, a glazing unit is provided which includes a transparent substrate and a vanadium dioxide (VO₂) containing layer on a surface of the transparent substrate. The surface of the transparent substrate has a surface roughness with a feature size in a range of 1 nm-200 nm, and the VO₂ containing layer includes a thin film of VO₂ doped to have a semiconductor-metal phase transition within a range of 10° C. to 40° C. deposited onto the surface.

According to another aspect, a double glazing unit includes an outer pane having a glazing unit as described herein and an inner pane adjacent the outer pane, the inner pane including another transparent substrate.

In yet another aspect, the VO₂ containing layer is formed on the inner surface of the outer pane.

In still another aspect, the double glazing unit includes a thermally reflective layer on the inner surface of the inner pane.

According to another aspect, a method of making a glazing unit is provided which includes forming a vanadium dioxide (VO₂) containing layer on a surface of a transparent substrate, the VO₂ containing layer being doped to have a semiconductor-metal phase transition within a range of 10° C. to 40° C. The step of forming the VO₂ containing layer includes at least one of: forming a plurality of core-shell nanoparticles with cores of transparent material and shells of VO₂, wherein a ratio of thicknesses of the cores to the shells is in a range of 1:1 to 50:1, and a size of the plurality of nanoparticles is in a range of 1 nm to 50 nm, and forming the VO₂ containing layer with the plurality of core-shell nanoparticles; or providing the surface of the transparent substrate with a surface roughness having a feature size in a range of 1 nm-200 nm, and depositing a thin film of VO₂ on the surface of the transparent substrate.

In accordance with another aspect, forming the VO₂ containing layer includes forming the VO₂ containing layer with the plurality of core-shell nanoparticles.

According to another aspect, a size of the plurality of nanoparticles is in a range of 1 nm to 50 nm.

According to yet another aspect, forming the VO₂ containing layer includes depositing the thin film of VO₂ on the surface of the transparent substrate.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### DESCRIPTION OF REFERENCE NUMERALS

1 solar visible light
2 solar near-infrared (NIR)
3 internal ambient heat
4 outer pane
5 inner pane
6 active layer
7 thermally reflective layer
8 VO₂ containing layer
9 10 nm core/1 nm shell
10 10 nm core/2 nm shell
11 10 nm core/5 nm shell
12 Mie scattering for low temperature
13 Mie scattering for high temperature

### BRIEF DESCRIPTION OF DRAWINGS

In the annexed drawings, like references indicate like parts or features:

FIG. 1 Concept of the Smart Window: In winter (or when outside temperature is less than a pre-determined level, for example 20° C.) all solar radiation is allowed to pass—visible light 1 and NIR 2; in summer (or when outside temperature is greater than a pre-determined level, for example 20° C.) only visible light 1 is allowed to pass—NIR 2 is not transmitted. In both cases internal ambient heat 3 can be reflected through use of suitable glazing products such as K-GLASS.

FIG. 2 Location of the active layer 6 of a Smart Window according to this invention. Location of the active layer 6 on the inside or inner surface of the outer pane 4 of the double glazing unit produces a response closely linked to the outside temperature. Location of the thermally reflective layer 7 on the internal or inner side of the adjacent inner pane 5 of the double glazing unit reflects the re-emitted radiation from the active layer 6, in this embodiment a VO₂ containing layer 8.

FIG. 3 Mie-scattering calculations of the optical properties of VO₂—SiO₂ core-shell particles at low temperature (upper plot): 9—10 nm core/1 nm shell; 10—10 nm core/2 nm shell; and 11—10 nm core/5 nm shell and high temperature (lower plot): 9—10 nm core/1 nm shell; 10—10 nm core/2 nm shell; and 11—10 nm core/5 nm shell (lower graph). The plot at high temperature (lower plot) shows the shift of the absorption to longer wavelengths with reducing shell size.

FIG. 4 Calculation of the optical properties of a glazing unit according to this invention (upper plot) using Mie-scattering (quasi-static approximation), 12—low temperature; 13—high temperature; and (lower plot) discrete dipole approximation, 12—low temperature; 13—high temperature,

### DETAILED DESCRIPTION OF INVENTION

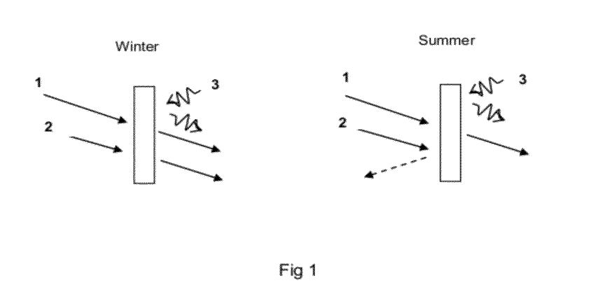

Referring to FIG. 1, the constituents of the current invention are chosen in order that the window:
1. Transmits solar visible light 1 under all ambient conditions
2. Transmits solar NIR 2 when the room temperature is low, and rejects it when the temperature is above a pre-determined (comfort) level
3. Reflects room ambient heat 3 back into the room

This invention is particularly related to coatings containing core-shell nanoparticles. The core is chosen to be a conventional, transparent dielectric material such as silicon dioxide (SiO₂). The shell is composed of vanadium dioxide (VO₂), doped with a suitable quantity of W, Al or Mg, Nb, Ta, Ir, Mo or other dopant known in the prior art, to lower the semiconductor-metal phase transition to within the range of 10° C. to 40° C., more preferably 20° C. to 25° C., and even more preferably to the approximate temperature at which the window is desired to switch characteristics, e.g., ˜25° C. The ratio of the thicknesses of the core to the shell is chosen in the range 1:1 to 50:1, and more preferably 1:1 to 10:1. The effect of changing this ratio is to selectively change the wavelength of the surface plasmon resonance from ˜1000 nm to 2500 nm. The particle size is chosen in the range 1 nm-50 nm, or more preferably in the range 1 nm-25 nm, to reduce scattering of visible light. Scattering of visible light is disadvantageous in a window/glazing product. In accordance with an embodiment of the invention, the core-shell particles can be dispersed in a suitable UV-stable host to form a coating or thin film. According to another embodiment, the desired spectral properties could also be achieved by deposition of thin film VO₂ onto glass that is structured with features of size 1 nm-200 nm, more preferably 1 nm-50 nm, and even more preferably 1 nm-25 nm. In this way similar surface plasmon resonances could be stimulated as for isolated particles.

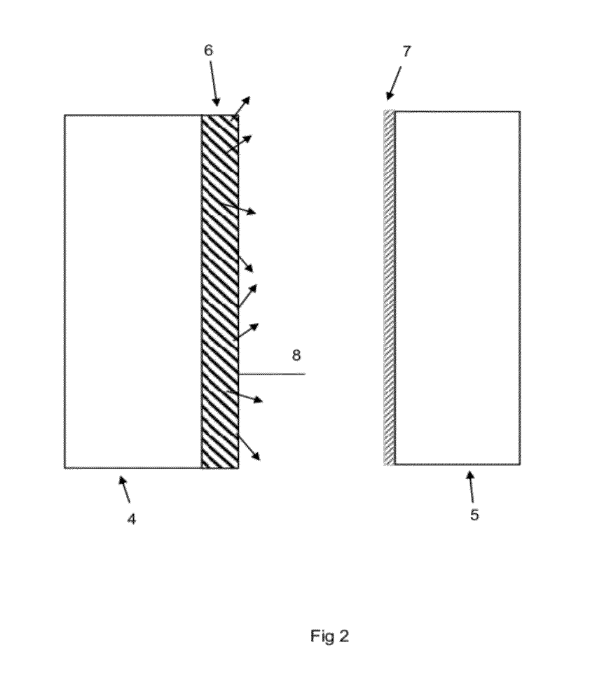

The VO₂ containing layer 8 in accordance with the present invention has a surface plasmon resonance in a range of 1000 nm-2500 nm. The VO₂ containing layer 8 can be used in conjunction with double glazing, and is applied to the inner surface of the outer pane 4 of glass, as shown in FIG. 2. In this way the VO₂ containing layer 8 can respond to the exterior/outside temperature. The internal surface of the inner pane 5 has a thin thermally reflective layer 7 of a material which is able to reflect infra-red radiation in the range 2 um-100 um, in order to reflect the radiation which is re-emitted by the VO₂ containing layer 8 following absorption of the solar NIR 2 radiation. This inner reflective layer 7 can be chosen from materials such as indium-doped tin oxide (as in used in K-GLASS) or from other materials such as silver, or from other multilayered combinations of these materials.

The use of this thermally reflective layer (sometimes referred to as “Low E”) on the internal surface also serves the function of reducing energy loss from inside the room by restricting radiation from the internal pane of glass towards the outer pane of glass (as per K-GLASS).

The spectral transmission and reflection requirements of the glass according to the invention are again shown schematically in FIG. 1. In more detail, the glass is desired to remain transparent to the whole solar spectrum (visible light 1 and NIR 2) when the temperature is below the pre-determined level, and become non-transmissive for wavelengths >800 nm when the temperature rises above the pre-determined level. The solar spectrum at ground level spans the approximate range 300 nm-2500 nm, thus the smart window should ideally not transmit in the range 800 nm-2500 nm when the temperature rises above the pre-determined level.

This can be achieved using core-shell nanoparticles in accordance with the present invention. The core of the nanoparticle is chosen from a transparent, inorganic material such as, but not limited to, silicon dioxide, titanium dioxide, zirconium dioxide or barium sulphate. The particle size is chosen in the range 1 nm-50 nm, more preferably 1 nm-25 nm. Calculations of the optical properties of particles using Mie scattering suggest that particles with diameter >50 nm cause excessive extinction through scattering, which is not desirable for a transparent glazing product.

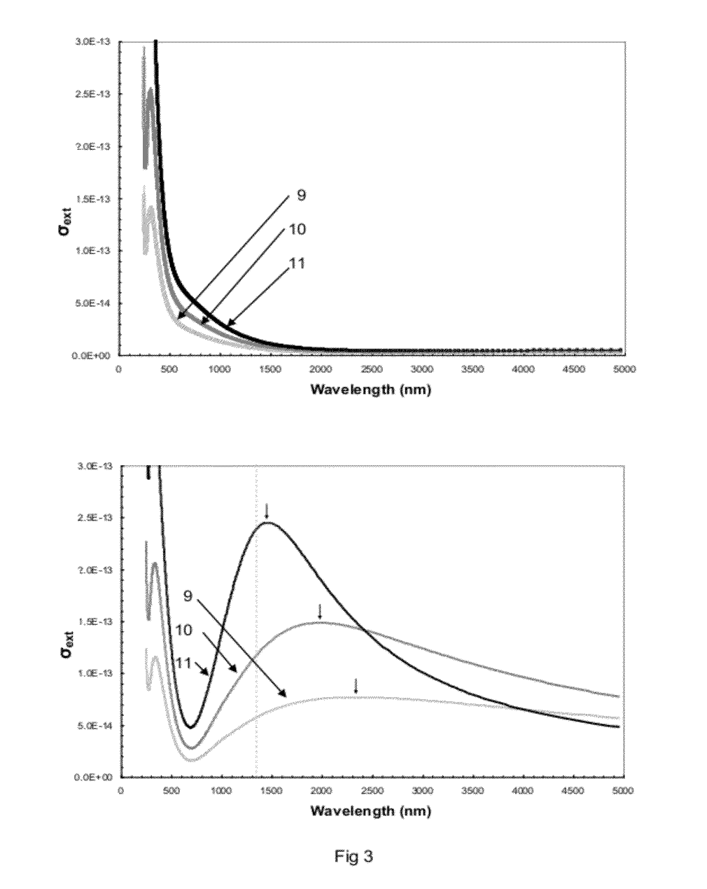

The shell of the particle is vanadium dioxide doped with a suitable quantity of W, Mg, Al, Nb, Ta, Ir, Mo or other metal known in the prior art to lower the semiconductor-metal phase transition to within the range of 10° C. to 40° C., more preferably 20° C. to 25° C., and even more preferably to the approximate temperature at which the window is desired to switch characteristics, e.g. ˜25° C. The ratio of thicknesses of the core to the shell is chosen in the range 1:1 to 50:1, or more preferably in the range 1:1 to 10:1. The effect of changing this ratio is to change the wavelength of the surface plasmon resonance from ˜1000 nm to 2500 nm. FIG. 3 shows calculations of the optical properties of 10 nm diameter core-shell particles based on the quasi-static approximation to Mie-scattering theory. This approximation is valid when the particle size is much smaller than the wavelength of the light. It shows how the spectral location of the surface plasmon absorption can be tuned according to the ratio of core to shell thickness—thin coatings produce absorptions at longer wavelengths. The location of the SPR can be tuned in the approximate range 1000 nm-2500 nm (or to even longer wavelengths for still thinner shells).

Particles according to this invention can be made in a variety of methods, one such example is the sol-gel method. In the sol-gel method, pre-synthesised SiO₂ particles are dispersed in a vanadium isopropoxide solution, whose concentration is adjusted the produce different thicknesses of VO₂. The core-shell particles are produced following hydrolysis, drying and annealing according to the approach described by Suzuki et al, Composites: Science and Technology, 67, (2002), 3487-3490. This paper describes a method to produce core-shell particles, but not for the purpose of producing a NIR SPR, which is tunable by modifying the core-shell thickness ratio, for solar NIR control.

Free-standing films can be made in accordance with the invention by dispersing the particles in a suitable transparent polymer host. The polymer should also be stable to UV, moisture and temperature cycling and can be chosen from the common thermoplastics such as acrylics, polyesters, epoxies, urethanes, polystyrene acrylonitrile butyl styrene and other polyoefins polymers such as polyethylene, polypropylene or cyclic olefin copolymers.

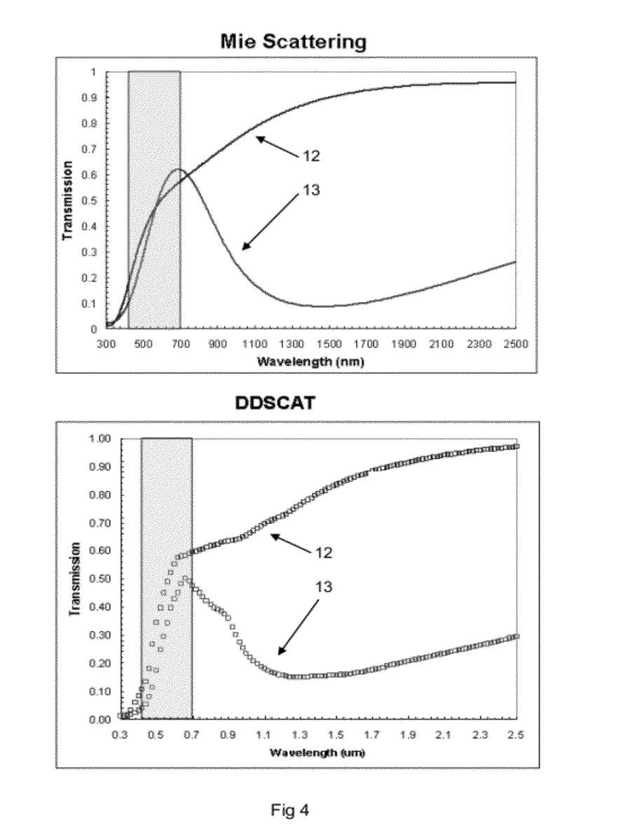

Example optical properties of particles dispersed in such a transparent polymer host are shown in FIG. 4. It shows properties calculated based on both Mie-scattering and the Discrete Dipole Approximation. It shows strong modulation of properties in the NIR part of the spectrum, whereas the properties in the visible part of the spectrum are relatively unchanged when the temperature is changed.

The particle size is chosen in the range 1 nm-50 nm, or more preferably in the range 1 nm-25 nm, to reduce scattering. The particles are dispersed in a suitable UV-stable host to form a coating or thin film. The desired spectral properties could also be achieved by deposition of thin film VO₂ onto glass that is structured with features of size 1 nm-200 nm, more preferably 1 nm-50 nm, and even more preferably 1 nm-25 nm, such that the SPR can be tuned in the approximate range of 1000 nm-2500 nm (or to even longer wavelengths). In this way similar surface plasmon resonances could be stimulated as for isolated particles.

Again, the VO₂ containing film(s) or layer(s) 8 are used in conjunction with double glazing, and are applied as the active layer 6 to the inner surface of the outer pane 4 of glass, as shown in FIG. 2. In this way it can respond to the exterior/outside temperature. The inner pane 5 of glass has the layer 7 of thermally reflective material which is able to reflect infra-red radiation in the range 2 um-100 um, in order to reflect the radiation which is re-emitted by the VO₂ following absorption of the solar NIR radiation. This inner reflective layer 7 can be chosen from materials such as indium-doped tin oxide (as in used in K-GLASS) or from other materials such as silver, or from other multilayered combinations of these materials.

The use of such a thermally reflective layer (sometimes referred to as “Low E”) on the internal surface also serves the function of reducing energy loss from inside the room by restricting radiation from the internal pane 5 of glass towards the outer pane 4 of glass (as per K-GLASS).

The glass panes 4 and/or 5 can be tinted to achieve a neutral colour using a suitable dye, pigment or suitable metal/semiconductor nanoparticle.

The present invention is particularly advantageous over the prior in that:
No power is required to be supplied to the unit to change the spectral properties so no wiring, etc. is required. The coating is therefore easy to implement in the form of a coating or window film
The spectral response of the active layer is chosen to minimise additional heating and/or cooling of the building since it allows heat to pass in cold conditions, and reflects it in hot conditions
The active component is wholly inorganic, so will have long lived properties

### Embodiment 1

An embodiment of this invention uses core-shell particles made using pre-synthesised 50 nm SiO₂ particles dispersed in a 0.5 mol/l solution of vanadium isopropoxide in 2-propanol and 2-methoxyethanol. Acetic acid is used as chelating agent. Hydrolysis is performed at a water/V molar ratio of 2:1. The resulting particles are dried at in air at 200° C., and then annealed at 600° C. for 1 hour in a nitrogen atmosphere. This process produces particles with a core diameter ˜50 nm and shell thickness ˜7 nm. According to this invention the SPR occurs at a wavelength of ˜2200 nm. Thicker shells are produced using higher isopropoxide solutions.

### Embodiment 2

This embodiment of the invention uses the particles of Embodiment 1 dispersed in a transparent polymer host, such as Bayers two-pack polyurethane Desmophen 850 by gentle agitation and draw-coated onto a glass substrate or other transparent substrate. The binder is allowed to dry to produce a Smart Window film. The glass substrate is mounted in a frame, with the VO₂ layer innermost, and then an additional pane of glass or other transparent substrate is mounted in the frame with a transparent indium-doped tin oxide layer innermost—facing the VO₂ layer. In this way a complete smart window is formed.

### Embodiment 3

A thin film of VO₂ doped as described above is deposited onto pre-structured glass or other transparent substrate via a suitable deposition technique such as PECVD. The glass or other substrate is pre-structured such that it contains surface roughness with feature size in the range 1 nm-200 nm. This pre-structuring can be achieved by a suitable lithography process such as electron beam lithography, UV interference lithography or block copolymer lithography. It could also use other nanoimprint lithography techniques. The optical properties of the final glass substrate are determined by the shape and size of the obtained features, and the thickness of the deposited VO₂. A double glazing unit is constructed using an additional piece of ITO coated glass—the VO₂ layer is on the internal face of the external pane of glass, the ITO layer is located on the internal surface of the internal pane of glass.

The present invention has been described herein in terms of the VO₂ containing layers and thermally reflective layers being formed on surfaces of the substrates.

It will be appreciated that in the context of the present invention, “being formed on a surface of a substrate” includes both the case of being formed directly on a surface of a bulk substrate, and the case where there may be one or more intervening layers between the bulk substrate and the VO₂ containing layers/thermally reflective layers (e.g., adhesion promoting layers, property enhancement layers, etc.).

It will be appreciated that as referred to herein, the term “transparent” does not require 100% transparency as such materials do not exist. Rather, materials described herein as being transparent in the context of allowing at least general passing of light within or throughout the visible spectrum.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

This invention is relevant to any structure containing large areas of glazing, e.g. office blocks, houses and greenhouses. It is also relevant to use in greenhouses since plants are sensitive to wavelengths at the red end of the visible spectrum.

1. A core-shell nanoparticle, comprising:
a core formed of a transparent material; and
a shell comprising vanadium dioxide (VO₂) doped to have a semiconductor-metal phase transition within a range of 10° C. to 40° C.,
wherein a ratio of thicknesses of the core to the shell is in a range of 1:1 to 50:1.

2. The nanoparticle according to claim 1, wherein the ratio is in a range of 1:1 to 10:1.

3. The nanoparticle according to claim 1, wherein the nanoparticle has a surface plasma resonance (SPR) within a range of 1000 nm-2500 nm.

4. The nanoparticle according to claim 1, wherein a size of the nanoparticle is in a range of 1 nm-50 nm.

5. The nanoparticle according to claim 1, wherein the core is made of any one or more of silicon dioxide, titanium dioxide, zirconium dioxide or barium sulphate.

6. The nanoparticle according to claim 1, wherein the VO₂ is doped with any one or more of W, Al, Mg, Nb, Ta, Ir or Mo.

7. A film, comprising:
a plurality of nanoparticles according to claim 1, dispersed in a transparent polymer host.

8. A glazing unit, comprising:
a transparent substrate; and
a VO₂ containing layer on a surface of the transparent substrate, the VO₂ containing layer comprising a plurality of nanoparticles according to claim 1.

9. The glazing unit according to claim 8, wherein the transparent substrate is a glass substrate.

10. A double glazing unit, comprising:
an outer pane comprising a glazing unit according to claim 8; and
an inner pane adjacent the outer pane, the inner pane comprising another transparent substrate.

11. The double glazing unit according to claim 10, wherein the VO₂ containing layer is formed on the inner surface of the outer pane.

12. The double glazing unit according to claim 11, comprising a thermally reflective layer on the inner surface of the inner pane.

13. A glazing unit, comprising:
a transparent substrate; and
a vanadium dioxide (VO₂) containing layer on a surface of the transparent substrate,
wherein the surface of the transparent substrate has a surface roughness with a feature size in a range of 1 nm-200 nm, and the VO₂ containing layer comprises a thin film of VO₂ doped to have a semiconductor-metal phase transition within a range of 10° C. to 40° C. deposited onto the surface.

14. A double glazing unit, comprising:
an outer pane comprising a glazing unit according to claim 13; and
an inner pane adjacent the outer pane, the inner pane comprising another transparent substrate.

15. The double glazing unit according to claim 14, wherein the VO₂ containing layer is formed on the inner surface of the outer pane.

16. The double glazing unit according to claim 14, comprising a thermally reflective layer on the inner surface of the inner pane.

17. A method of making a glazing unit, comprising:
forming a vanadium dioxide (VO₂) containing layer on a surface of a transparent substrate, the VO₂ containing layer being doped to have a semiconductor-metal phase transition within a range of 10° C. to 40° C.,
wherein the step of forming the VO₂ containing layer comprises at least one of:
forming a plurality of core-shell nanoparticles with cores of transparent material and shells of VO₂, wherein a ratio of thicknesses of the cores to the shells is in a range of 1:1 to 50:1, and forming the VO₂ containing layer with the plurality of core-shell nanoparticles; or
providing the surface of the transparent substrate with a surface roughness having a feature size in a range of 1 nm-200 nm, and depositing a thin film of VO₂ on the surface of the transparent substrate.

18. The method according to claim 17, wherein the step of forming the VO₂ containing layer comprises forming the VO₂ containing layer with the plurality of core-shell nanoparticles.

19. The method according to claim 18, wherein a size of the plurality of nanoparticles is in a range of 1 nm to 50 nm.

20. The method according to claim 17, wherein the step of forming the VO₂ containing layer comprises depositing the thin film of VO₂ on the surface of the transparent substrate.
